(19) United States
(12) Patent Application Publication
(10) Pub. No.: US 2026/0356329 A1
(43) Pub. Date: Nov. 12, 2026

(54) DEVICE FOR CLEANING A SURFACE OF AN OPTICAL ELEMENT, DETECTION SYSTEM AND VEHICLE

(71) Applicant: VALEO SYSTEMES D'ESSUYAGE, La Verriere (FR)

(72) Inventors: Maxime BAUDOUIN, La Verriere (FR); Nicolas HORNYCH, La Verriere (FR); Quentin FAURIOL, La Verriere (FR); Nicolas KUCHLY, La Verriere (FR)

(73) Assignee: VALEO SYSTEMES D'ESSUYAGE, La Verriere (FR)

(21) Appl. No.: 19/134,860

(22) PCT Filed: Dec. 13, 2023
(86) PCT No.: PCT/EP2023/085540

§ 371 Date: Jun. 2, 2025

(30) Foreign Application Priority Data
Dec. 13, 2022 (FR) FR2213278

(51) Int. Cl. B60S 1/52; B60S 1/54; G01S 7/497

(52) U.S. Cl. CPC B60S 1/52; B60S 1/54; G01S 2007/4977

(57) ABSTRACT

The invention proposes a device for cleaning a surface of an optical element of a vehicle. The device includes an air nozzle with an outlet oriented toward the surface of the optical element and a cleaning liquid spray nozzle including outlet ports oriented toward the surface of the optical element. The cleaning liquid spray nozzle and the air nozzle being configured to spray the cleaning liquid and the air onto the surface of the optical element from the same side of the surface of the optical element. The invention also relates to a detection system for a vehicle including the device, and to a vehicle including the system. The invention makes it possible to make the cleaning device smaller.

### TECHNICAL FIELD

The invention relates to a device for cleaning a surface of an optical element, a detection system comprising the cleaning device, and a vehicle comprising the detection system.

### BACKGROUND OF THE INVENTION

Optical sensors, particularly position sensors, which are now fitted in a great many motor vehicles, have the function of gathering information on the area surrounding the vehicle, in particular to assist the driver in driving and/or maneuvering this vehicle. To this end, an optical sensor is commonly installed on the vehicle so as to collect information on the area surrounding the vehicle such as the area to the front and/or rear of the vehicle: the detection system is therefore for example installed in the front face and/or in the rear face.

However, such locations are particularly exposed to dirt such as dirty water, dust or other types of thrown-up debris. This dirt hinders the transmission and reception of information and can disrupt the operation of the optical element, or even stop it from operating.

EP3988837 proposes a vehicle cleaning system for cleaning a front LIDAR of a vehicle, the cleaning system comprising a liquid nozzle configured to eject cleaning liquid toward the LIDAR through ejection ports and a fan configured to eject air toward the LIDAR through an air nozzle, wherein the directions of the ejection ports of the liquid nozzle and of the air nozzle are perpendicular to each other. The drawback of such a device is that it is large.

There is a need for a device for cleaning a surface of an optical element that is smaller.

### SUMMARY OF THE INVENTION

The aim of the invention is to provide a device for cleaning a surface of an optical element that is smaller.

To this end, the invention proposes a device for cleaning a surface of an optical element of a vehicle, comprising an air nozzle with an outlet oriented toward the surface of the optical element and a cleaning liquid spray nozzle comprising outlet ports oriented toward the surface of the optical element, the cleaning liquid spray nozzle and the air nozzle being configured to spray the cleaning liquid and the air onto the surface of the optical element from the same side of the surface of the optical element.

According to one variant, the cleaning liquid spray nozzle is arranged to emerge closer to the surface of the optical element than the air nozzle.

According to one variant, the air nozzle is arranged to emerge closer to the surface of the optical element than the cleaning liquid spray nozzle.

According to one variant, the cleaning liquid spray nozzle is fastened to the air nozzle so that the cleaning liquid is sprayed into the air nozzle.

According to one variant, the cleaning liquid spray nozzle and the air nozzle are capable of spraying the liquid and the air separately onto the surface of the optical element.

According to one variant, the cleaning liquid spray nozzle and the air nozzle are capable of spraying the liquid and the air jointly onto the surface of the optical element.

According to one variant, the cleaning liquid spray nozzle and the air nozzle are superposed.

According to one variant, the air nozzle and the cleaning liquid spray nozzle are capable of spraying the air and the liquid in directions of propagation of the air and the liquid on the surface of the optical element that are parallel.

According to one variant, the air nozzle and the cleaning liquid spray nozzle are capable of spraying the air and the liquid in directions of propagation of the air and the liquid that intersect each other, until the air and the liquid reach the surface of the optical element. Once the air and the liquid are in contact with the surface of the optical element, the air and the liquid propagate on the surface of the optical element in a common parallel direction.

According to one variant, the air nozzle and the cleaning liquid spray nozzle are offset from each other along one side of the surface of the optical element.

According to one variant, the device further comprises a member for blowing air through the air nozzle, the blowing member being a fan or a compressor.

The invention also relates to a detection system for a vehicle comprising an optical element comprising a surface for detecting the surrounding area and a cleaning device as described above, configured to clean the surface of the optical element.

According to one variant, the air nozzle and the cleaning liquid spray nozzle are on the same side of the detection surface, selected from among an upper side, a lower side, and a lateral side.

The invention also relates to a vehicle comprising the system as described above.

All of the preferred embodiments and all of the advantages of the cleaning device according to the invention can be transferred, mutatis mutandis, to the present cleaning system and to the vehicle, and vice versa. The different embodiments can be taken in combination or considered in isolation.

### BRIEF DESCRIPTION OF DRAWINGS

Further features and advantages of the invention will become apparent on reading the following detailed description, which will be more clearly understood with reference to the appended drawings, in which:

FIG. 1 is a view of an example of a cleaning device;

FIG. 2 is a side view of the device in FIG. 1;

FIG. 3 is a view of another example of a cleaning device;

FIG. 4 is a view of another example of a cleaning device;

FIG. 5 is a view of another example of a cleaning device; and

FIG. 6 is a side view of the device in FIG. 5.

The drawings in the figures are not to scale. Similar elements are generally denoted by similar reference signs in the figures. In the context of this document, identical or similar elements can bear the same reference signs. Furthermore, the presence of reference numbers or letters in the drawings cannot be considered limiting, including when these numbers or letters are indicated in the claims.

### DETAILED DESCRIPTION OF THE INVENTION

The invention proposes a device for cleaning a surface of an optical element of a vehicle. The cleaning device comprises an air nozzle with an outlet oriented toward the surface of the optical element and a cleaning liquid spray nozzle comprising outlet ports oriented toward the surface of the optical element. The cleaning liquid spray nozzle and the air nozzle are configured to spray the cleaning liquid and the air onto the surface of the optical element from the same side of the surface of the optical element. This makes it possible to make the cleaning device smaller.

FIG. 1 shows an example of a cleaning device 10 according to the invention. The device 10 makes it possible to clean a surface 12 of at least one optical element 14 of a vehicle. The optical element 14 can be a driving assistance means. The optical element 14 makes it possible to gather information about the position of and the area surrounding the motor vehicle, in particular to assist the driver in driving and/or maneuvering this vehicle. It can be an image capturing means for assisting the driver in particular in performing parking and/or reversing maneuvers (a camera, for example); it can also be a signal transmitting and/or receiving means, likewise for assisting the driver in performing maneuvers but also in driving (such as a sensor, an optical sensor, for example a LIDAR, which stands for “light detection and ranging” or “laser imaging, detection, and ranging”).

The optical element 14 interacts with the surrounding area through the surface 12, particularly an optical surface 12. In general, the surface 12 is a flat or non-flat (such as a curved or even cylindrical) expanse. The surface is bounded by sides 121, 122, etc. The sides of the surface are the boundaries, the ends of the surface, in different directions in space. These can also be the sides, the boundaries, of a zone of the physical surface of the optical element, which could be classified as a zone of interest through which the optical element interacts with the surrounding area; the zone of interest can therefore be equal to or smaller than the physical surface of the optical element. Depending on the shape of the surface 12, the sides can be straight, curved or other. By way of example, the surface 12 in the figures is flat and comprises four sides 121, 122, 123, 124. In the case of a cylindrical surface, the sides are the boundary between the lateral envelope of the cylinder and the disks on either side of the lateral envelope.

The surface 12 can be a protective surface between the optical element and the surrounding area. For example, it can be the surface of a sheet of glass fitted between the optical element and the surrounding area, or a surface of a casing that encloses a sensor (such as a face of a LIDAR casing). It can be a constituent part of the optical element, such as the surface of a focusing lens of a camera. The surface can be opaque (to the visible wavelengths). The surface can be transparent to the transmission and reception wavelengths of the optical element. It is also possible to envisage a plurality of optical elements interacting with the surrounding area through a single surface 12.

The device 10 performs the cleaning of the surface 12. More specifically, the device 10 performs the cleaning of the optical surface 12 without making contact with the surface or moving cleaning members. This makes it possible to clean both dust and thrown-up solid debris or liquid splashes from the optical surface 12 in a way that is robust over time and effective. The operation of the optical element 14 is thus improved.

The device 10 comprises an air nozzle 16 with an outlet oriented toward the surface 12 of the optical element 14. The nozzle 16 is capable of spraying air onto the surface 12 in order to remove drops of liquid, such as raindrops or drops of cleaning liquid for example. The nozzle 16 generally makes it possible to prevent stagnant drops of liquid on the surface 12 that would be detrimental to the satisfactory operation of the optical element 14. The device 10 also comprises a liquid spray nozzle 18 comprising outlet ports oriented toward the surface 12 of the optical element 14. The spray nozzle 18 is capable of spraying a pressurized cleaning liquid onto the surface 12 in order to clean any dust, soil, or insects from the surface 12. The spray nozzle 18 generally makes it possible to prevent any stagnant solid debris on the surface 12 that would be detrimental to the satisfactory operation of the optical element 14.

The spray nozzle 18 and the nozzle 16 are configured to spray the cleaning liquid and the air respectively onto the surface 12 of the optical element 14 from the same side of the surface of the optical element 14. In other words, the spray nozzle 18 and the nozzle 16 are in the same orientation relative to the surface. This makes it possible to better incorporate the spray nozzle 18 and the nozzle 16 into the area surrounding the surface 12 so as to make the cleaning device smaller. In addition, the surface can be cleaned by activating the washing function (by the spray nozzle, with the cleaning liquid) and the blowing function (by the nozzle, with the air) sequentially, simultaneously, or independently of each other. The spray nozzle 18 and the nozzle 16 are capable of spraying the liquid and the air separately onto the surface of the optical element. The functions can thus be activated separately one after the other (whatever the order of the functions), sequentially, or independently of each other. The spray nozzle 18 and the nozzle 16 are also capable of spraying the liquid and the air jointly onto the surface of the optical element. The functions can thus be activated simultaneously. Whatever the operation, cleaning is improved. In addition, when the two functions are activated simultaneously, this ensures improved stability of the stream of liquid on the surface 12 and therefore improved cleaning of the surface.

In the figures, the spray nozzle 18 and the nozzle 16 are on the side 121. However, the spray nozzle 18 and the nozzle 16 can be positioned on any one of the sides of the surface 12. Implementation on the side 121, which corresponds to an upper side of the surface when the optical element 14 is in place in a vehicle, is advantageous for low-speed vehicles, as the air stream of the vehicle does not interfere with the propagation of the air and the liquid on the surface. Implementation on the side 123 opposite the side 121, which corresponds to a lower side of the surface when the optical element 14 is in place in a vehicle, is advantageous for high-speed vehicles or on the roof of the vehicle, as the air stream of the vehicle promotes the propagation of the air and the liquid on the surface. Implementation on the side 122 or the side 124, which correspond to the lateral sides of the surface when the optical element 14 is in place in a vehicle, is advantageous for a position of the optical element 14 on a wing of the vehicle.

It should be noted that the spray nozzle 18 and the nozzle 16 can be on the same side of the surface 12, which can be the physical boundary of the surface as described above. However, the spray nozzle 18 and the nozzle 16 can be on the same side of the zone of interest of the surface 12. The same considerations described apply to the zone of interest of the surface 12.

The air nozzle 16 and the cleaning liquid spray nozzle 18 are capable of spraying the air and the liquid in directions of propagation of the air and the liquid on the surface of the optical element that are parallel. In other words, once the air and the liquid have been sprayed onto the surface 12, the air and the liquid propagate on the surface in a common parallel direction.

According to one variant, the air nozzle 16 and the cleaning liquid spray nozzle 18 are capable of spraying the air and the liquid in directions of propagation of the air and the liquid that intersect each other, until the air and the liquid reach the surface 12 of the optical element. Once the air and the liquid are in contact with the surface 12 of the optical element, the air and the liquid propagate on the surface 12 of the optical element in a common parallel direction.

Because the air and the liquid have been sprayed from the same side of the surface, they propagate in the same direction on the surface 12. The directions in which the air and the liquid flush the surface are coincident. This is particularly true when the vehicle is stopped or at low or reduced speed. According to the figures, with the spray nozzle 18 and the nozzle 16 on the upper edge 121, the air and the liquid propagate from top to bottom on the surface 12. From the lower side 123, the air and the liquid propagate from bottom to top on the surface 12. From one of the lateral sides 122 or 124, the air and the liquid propagate from left to right or right to left on the surface 12. The advantage of propagation in the same direction is that the streams can be better managed on the surface 12 and the surface 12 can thus be better cleaned.

The cleaning device 10 can comprise a member 20 for blowing air through the air nozzle 16. The blowing member 20 supplies the nozzle 16 with air. An air line 22 conveys the air from the blowing member 20 to the nozzle 16. The positioning of the blowing member 20 in the vicinity of the optical element 14 depends on the space available around the optical element 14. Preferably, the blowing member 20 is positioned behind the optical element 14, or in other words on the opposite side from the surface 12. This makes it possible both to start to shape the air stream before it reaches the nozzle 16, and to place the blowing member in a position that does not interfere with the detection of the surrounding area by the optical element 14. The blowing member 20 can be a fan or a compressor. A fan makes it possible to achieve blowing toward the nozzle 16 that is continuous, with a high air flow rate and lower pressure. A compressor is an actuator that makes it possible to compress the air, which can be distributed by discharging means, such as a solenoid valve. A compressor makes it possible to achieve blowing towards the nozzle 16 that is intermittent and high-frequency, with a lower air flow rate than the flow rate generated by the fan and with higher pressure than the pressure generated by the fan. The implementation of the fan or the compressor depends on the space available around the optical element 14 and on the type of optical element 14.

The spray nozzle 18 and the nozzle 16 can be implemented in several ways.

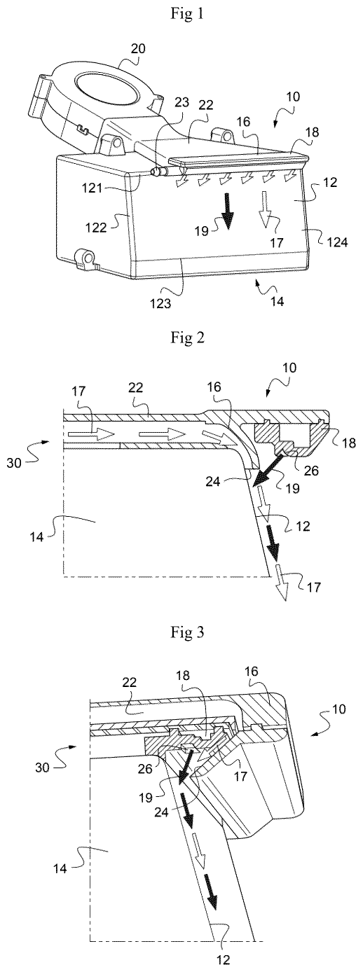

In FIG. 1 and FIG. 2, the air nozzle 16 is arranged to emerge closer to the surface of the optical element 14 than the cleaning liquid spray nozzle 18. FIG. 2 shows a side view of the device 10 in FIG. 1. The nozzle 16 is supplied with air by the line 22 (in turn connected to the blowing member 20). The line 22 allows initial shaping of the air stream 17 before it reaches the nozzle 16. The nozzle 16 allows shaping suitable for satisfactory propagation of the air on the surface 12. The nozzle 16 can be shaped for particular shaping of the air stream. The air 17 is sprayed at the outlet 24 of the nozzle 16 as close as possible to the surface 12. The spray is tangential to the surface 12. Tangential spraying of the air on the surface 12 (or at an angle of less than 10°) is advantageous in order to limit the turbulence caused by the air. The air stream is thus more consistent along the surface 12. The liquid 19 is sprayed from the outlet ports 26 of the spray nozzle 18 onto the surface 12. The spray of liquid is further from the surface than the spray of air. A spray of liquid with an angle of incidence of between 10° and 40°, preferably 15°, is conducive to satisfactory propagation of the liquid on the surface 12. According to FIG. 1 and FIG. 2, the washing and blowing functions are superposed; the spray nozzle 18 and the nozzle 16 are superposed. The spray nozzle 18 is on the nozzle 16. The spray nozzle can be supported by the nozzle 16. The spray nozzle 18 sprays the liquid into the air stream on the surface. Once the surface 12 has been reached, the liquid 19 and the air 17 propagate on the surface in common parallel directions.

In FIG. 3, the cleaning liquid spray nozzle 18 is arranged to emerge closer to the surface of the optical element 14 than the air nozzle 16. FIG. 3 is a side view of the device 10. The liquid 19 is sprayed from the outlet ports 26 of the spray nozzle 18 as close as possible to the surface 12. The spray of liquid 19 can be tangential to the surface or inclined by an angle of less than 10°. The spray of air 17 is further from the surface than the spray of liquid 19. The nozzle 16 is supplied with air in the same way as above by the line 22 (in turn connected to the blowing member 20). The line 22 is positioned above the spray nozzle 18. The line 22 allows initial shaping of the air stream 17 before it reaches the nozzle 16. The nozzle 16 allows shaping suitable for satisfactory propagation of the air on the surface 12. The nozzle 16 can be shaped for particular shaping of the air stream. According to FIG. 3, the washing and blowing functions are superposed; the spray nozzle 18 and the nozzle 16 are superposed. The nozzle 16 can be on the spray nozzle 18. The nozzle 16 can be supported by the spray nozzle 18. The nozzle 16 is superposed on the spray nozzle 18. The nozzle 16 sprays the air into the liquid stream on the surface, where applicable. Once the surface 12 has been reached, the liquid 19 and the air 17 propagate on the surface in common parallel directions.

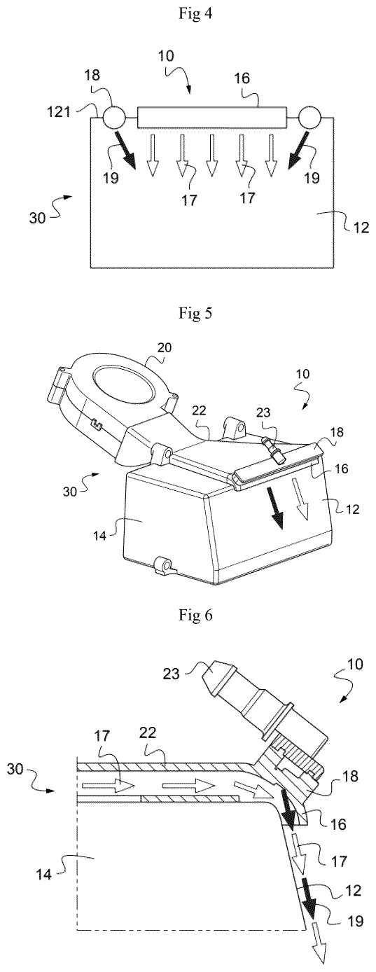

According to FIG. 4, the spray nozzle 18 and the nozzle 16 are on the same side 121, but are offset from each other along the side 121 of the surface 12 of the optical element 14. The spray nozzle 18 and the nozzle 16 are side by side. This allows both the nozzle 16 and the spray nozzle 18 to emerge as close as possible to the surface 12 of the optical element 14. This makes it possible to have air and liquid streams that are tangential to the surface 12. The provision of an additional spray nozzle 18 can also be envisaged. One spray nozzle 18 can be provided on either side of the nozzle 16. The nozzle 16 is between the spray nozzles 18. The spray nozzle 18 and the nozzle 16 are capable of spraying the liquid and the air separately onto the surface of the optical element. The functions can thus be activated separately one after the other (whatever the order of the functions), sequentially, or independently of each other. The spray nozzle 18 and the nozzle 16 are also capable of spraying the liquid and the air jointly onto the surface of the optical element. The functions can thus be activated simultaneously. The same advantages as above are provided here.

FIG. 5 shows another example of the cleaning device 10. FIG. 6 shows a side view of the device 10 in FIG. 5. The nozzle 16 is arranged to emerge closer to the surface 12 of the optical element than the spray nozzle 18. The cleaning liquid spray nozzle 18 is fastened to the air nozzle 16 so that the cleaning liquid is sprayed into the air nozzle. Whether the washing or blowing functions are activated sequentially, simultaneously, or independently of each other, this thus makes it possible to orient both of the streams at the outlet of the nozzle 16 tangentially to the surface 12. The air and the liquid are thus sprayed onto the surface 12 in directions of propagation of the air and the liquid on the surface of the optical element that are parallel. In the event of simultaneous activation of the washing and blowing functions, the stream of liquid 19 is sprayed directly into the air stream. This makes it possible to have streams that carry each other, which improves the cleaning of the surface 12. In the embodiment in FIG. 5 and FIG. 6, the washing and blowing functions are superposed; the spray nozzle 18 and the nozzle 16 are superposed. The spray nozzle 18 can be supported by the nozzle 16. The spray nozzle 18 can be superposed on the nozzle 16.

The cleaning device 10 can comprise a pump (not shown in the figures) for supplying the spray nozzle 18 with cleaning liquid. The pump can be connected by a hose (not shown) to a liquid inlet 23 of the spray nozzle 18. According to FIG. 1, the inlet 23 is at one end of the spray nozzle 18. According to FIG. 5, the inlet 23 is between the ends of the spray nozzle 18. Other positions of the inlet 23 relative to the spray nozzle 18 can be envisaged.

The invention also relates to a detection system 30 for a vehicle comprising the optical element 14 with the surface 12 for detecting the surrounding area and the cleaning device 10, configured to clean the surface 12 of the optical element 14. Due to the positioning of the nozzle 16 and the spray nozzle 18 on the same side of the surface 12, the size of the device 10 is reduced. In addition, because the air and liquid streams come from the same side, or are parallel on the surface 12, this makes it possible to activate the washing and blowing functions sequentially, simultaneously, or independently of each other. This provides more options for cleaning the surface, and therefore makes it possible to obtain high-quality cleaning over time of the optical element. It is possible to position the spray nozzle 18 and the nozzle 16 on an upper side 121, a lower side 123, or a lateral side 122, 124, which offers different possible configurations for cleaning the surface, depending on the vehicle and the positioning of the optical element 14 in the vehicle. The invention also relates to a vehicle comprising the system described. This improves the driving and driver assistance of the vehicle.

The present invention has been described in relation to specific embodiments, which have purely illustrative value and should not be considered limiting. In general, it will be obvious to a person skilled in the art that the present invention is not limited to the examples illustrated and/or described above.

1. A device for cleaning a surface of an optical element of a vehicle, comprising
an air nozzle with an outlet oriented toward the surface of the optical element, and
a cleaning liquid spray nozzle including outlet ports oriented toward the surface of the optical element,
the cleaning liquid spray nozzle and the air nozzle being configured to spray the cleaning liquid and the air onto the surface of the optical element from a same side of the surface of the optical element.

2. The device for cleaning a surface of an optical element of a vehicle as claimed in claim 1, wherein the cleaning liquid spray nozzle is arranged to emerge closer to the surface of the optical element than the air nozzle.

3. The device for cleaning a surface of an optical element of a vehicle as claimed in claim 1, wherein the air nozzle is arranged to emerge closer to the surface of the optical element than the cleaning liquid spray nozzle.

4. The device for cleaning a surface of an optical element of a vehicle as claimed in claim 3, wherein the cleaning liquid spray nozzle is fastened to the air nozzle so that the cleaning liquid is sprayed into the air nozzle.

5. The device for cleaning a surface of an optical element of a vehicle as claimed in claim 1, wherein the cleaning liquid spray nozzle and the air nozzle are capable of spraying the liquid and the air separately onto the surface of the optical element.

6. The device for cleaning a surface of an optical element of a vehicle as claimed in claim 1, wherein the cleaning liquid spray nozzle and the air nozzle are capable of spraying the liquid and the air jointly onto the surface of the optical element.

7. The device for cleaning a surface of an optical element of a vehicle as claimed in claim 1, wherein the cleaning liquid spray nozzle and the air nozzle are superposed.

8. The device for cleaning a surface of an optical element of a vehicle as claimed in claim 1, wherein the air nozzle and the cleaning liquid spray nozzle are capable of spraying the air and the liquid in directions of propagation of the air and the liquid on the surface of the optical element that are parallel.

9. The device for cleaning a surface of an optical element of a vehicle as claimed in claim 1, wherein the air nozzle and the cleaning liquid spray nozzle are capable of spraying the air and the liquid in directions of propagation of the air and the liquid that intersect each other, until the air and the liquid reach the surface of the optical element.

10. The device for cleaning a surface of an optical element of a vehicle as claimed in claim 1, wherein the air nozzle and the cleaning liquid spray nozzle are offset from each other along one side of the surface of the optical element.

11. The device for cleaning a surface of an optical element of a vehicle as claimed in claim 1, further comprising a member for blowing air through the air nozzle, the blowing member being a fan or a compressor.

12. A detection system for a vehicle comprising an optical element with a surface for detecting the surrounding area and a cleaning device configured to clean the surface of the optical element, wherein the cleaning device includes an air nozzle with an outlet oriented toward the surface of the optical element, and a cleaning liquid spray nozzle including outlet ports oriented toward the surface of the optical element, with the cleaning liquid spray nozzle and the air nozzle being configured to spray the cleaning liquid and the air onto the surface of the optical element from a same side of the surface of the optical element.

13. The system as claimed in claim 12, wherein the air nozzle and the cleaning liquid spray nozzle are on a same side of the detection surface, selected from among an upper side, a lower side, and a lateral side.

14. A vehicle comprising a detection system, the detection system includes an optical element with a surface for detecting the surrounding area and a cleaning device configured to clean the surface of the optical element, wherein the cleaning device includes an air nozzle with an outlet oriented toward the surface of the optical element, and a cleaning liquid spray nozzle including outlet ports oriented toward the surface of the optical element, with the cleaning liquid spray nozzle and the air nozzle being configured to spray the cleaning liquid and the air onto the surface of the optical element from a same side of the surface of the optical element.
